(19) United States
(12) Patent Application Publication
(10) Pub. No.: US 2025/0287005 A1
(43) Pub. Date: Sep. 11, 2025

(54) TRANSFORM KERNEL DERIVATION IN INTER-CODED BLOCK WITH INTRA PREDICTION MODE INFORMATION

(71) Applicant: Tencent America LLC, Palo Alto, CA (US)

(72) Inventors: Biao WANG, San Jose, CA (US); Roman CHERNYAK, Santa Clara, CA (US); Lien-Fei CHEN, Palo Alto, CA (US); Yonguk YOON, Palo Alto, CA (US); Motong XU, Palo Alto, CA (US); Ziyue XIANG, Palo Alto, CA (US); Yifan WANG, Palo Alto, CA (US); Shan LIU, San Jose, CA (US)

(73) Assignee: Tencent America LLC, Palo Alto, CA (US)

(21) Appl. No.: 19/072,848

(22) Filed: Mar. 6, 2025

Related U.S. Application Data
(60) Provisional application No. 63/563,168, filed on Mar. 8, 2024.

(51) Int. Cl. H04N 19/132; H04N 19/172; H04N 19/176; H04N 19/18; H04N 19/61

(52) U.S. Cl. CPC H04N 19/132; H04N 19/172; H04N 19/176; H04N 19/18; H04N 19/61

(57) ABSTRACT

An aspect of the disclosure provides a method of video decoding. For example, a coded video bitstream is received. The coded video bitstream includes coded information of a plurality of pictures. Based on the coded information, a current block in a current picture is determined to be coded using an inter prediction mode, prediction samples of the current block in the inter prediction mode are generated at least partially based on a reference block in a reference picture that is different from the current picture. Also, intra prediction mode associated with the current block in the current picture is obtained. One or more transform kernels are determined based on the intra prediction mode associated with the current block. The current block is reconstructed based on the one or more transform kernels.

### INCORPORATION BY REFERENCE

The present application claims the benefit of priority to U.S. Provisional Application No. 63/563,168, filed on Mar. 8, 2024, which is incorporated by reference herein in its entirety.

### TECHNICAL FIELD

The present disclosure describes aspects generally related to video coding.

### BACKGROUND

The background description provided herein is for the purpose of generally presenting the context of the disclosure. Work of the presently named inventors, to the extent the work is described in this background section, as well as aspects of the description that may not otherwise qualify as prior art at the time of filing, are neither expressly nor impliedly admitted as prior art against the present disclosure.

Image/video compression can help transmit image/video data across different devices, storage and networks with minimal quality degradation. In some examples, video codec technology can compress video based on spatial and temporal redundancy. In an example, a video codec can use techniques referred to as intra prediction that can compress an image based on spatial redundancy. For example, the intra prediction can use reference data from the current picture under reconstruction for sample prediction. In another example, a video codec can use techniques referred to as inter prediction that can compress an image based on temporal redundancy. For example, the inter prediction can predict samples in a current picture from a previously reconstructed picture with motion compensation. The motion compensation can be indicated by a motion vector (MV).

### SUMMARY

Aspects of the disclosure include bitstreams, methods and apparatuses for video encoding/decoding. In some examples, an apparatus for video encoding/decoding includes processing circuitry.

An aspect of the disclosure provides a method of video decoding. For example, a coded video bitstream is received. The coded video bitstream includes coded information of a plurality of pictures. Based on the coded information, a current block in a current picture is determined to be coded using an inter prediction mode, prediction samples of the current block in the inter prediction mode are generated at least partially based on a reference block in a reference picture that is different from the current picture. Also, intra prediction mode associated with the current block in the current picture is obtained. One or more transform kernels are determined based on the intra prediction mode associated with the current block. The current block is reconstructed based on the one or more transform kernels.

Another aspect of the disclosure provides a method of video encoding. For example, to code a current block in a current picture using an inter prediction mode is determined. Prediction samples for samples of the current block are generated at least partially based on a reference block in a reference picture that is different from the current picture. An intra prediction mode associated with the current block in the current picture is obtained. One or more transform kernels are determined based on the intra prediction mode associated with the current block. The current block is encoded as bits in a bitstream based on the one or more transform kernels.

Another aspect of the disclosure provides a method of processing visual media data is provided. In the method, a conversion between a visual media file and a bitstream of visual media data is performed according to a format rule. In an example, the bitstream carries coded information of a plurality of pictures. The format rule specifies that a current block in a current picture is coded using an inter prediction mode, prediction samples of the current block in the inter prediction mode are generated at least partially based on a reference block in a reference picture that is different from the current picture. The format rule also specifies that an intra prediction mode associated with the current block in the current picture is obtained, one or more transform kernels are determined based on the intra prediction mode associated with the current block, and the current block is reconstructed based on the one or more transform kernels.

Aspects of the disclosure also provide an apparatus for video encoding. The apparatus for video encoding including processing circuitry configured to implement any of the described methods for video encoding.

Aspects of the disclosure also provide a method for video decoding. The method including any of the methods implemented by the apparatus for video decoding.

Aspects of the disclosure also provide a non-transitory computer-readable medium storing instructions which, when executed by a computer, cause the computer to perform any of the described methods for video decoding/encoding.

### BRIEF DESCRIPTION OF THE DRAWINGS

Further features, the nature, and various advantages of the disclosed subject matter will be more apparent from the following detailed description and the accompanying drawings in which:

FIG. 1 is a schematic illustration of an example of a block diagram of a communication system (100).

FIG. 2 is a schematic illustration of an example of a block diagram of a decoder.

FIG. 3 is a schematic illustration of an example of a block diagram of an encoder.

FIG. 4 shows a diagram of 24 angles that are used in geometric partition mode (GPM) in some examples.

FIG. 5 shows a diagram of possible partition edges for the angle index 3 in an example.

FIG. 6 shows an example of a table that maps intra prediction modes to low-frequency non-separable transform (LFNST) sets.

FIG. 7 shows a diagram of a block in the GPM mode in an example.

FIG. 8 shows a diagram of a block in the GPM mode in an example.

FIG. 9 shows a flow chart outlining a decoding process according to some aspects of the disclosure.

FIG. 10 shows a flow chart outlining an encoding process according to some aspects of the disclosure.

FIG. 11 is a schematic illustration of a computer system in accordance with an aspect.

### DETAILED DESCRIPTION

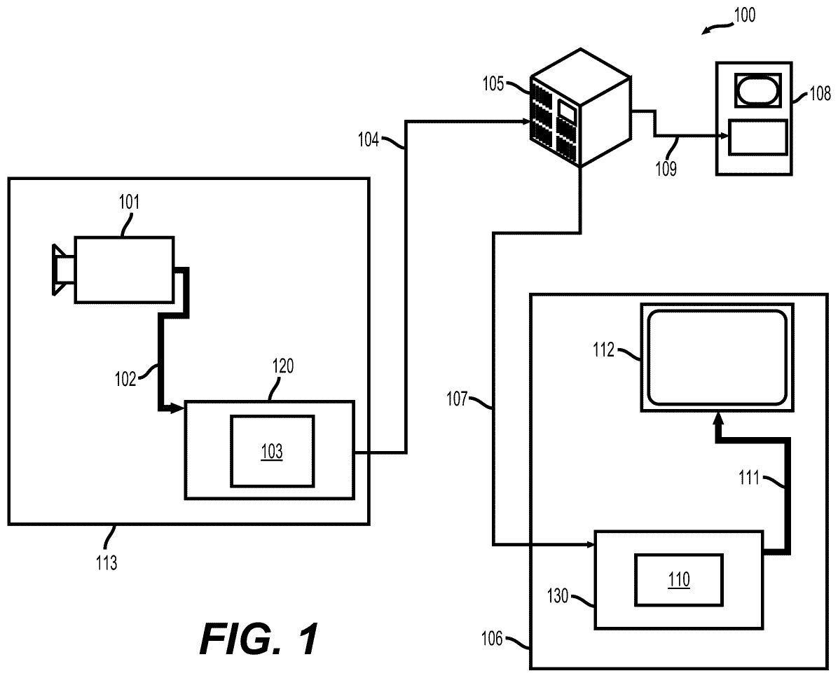

FIG. 1 shows a block diagram of a video processing system (100) in some examples. The video processing system (100) is an example of an application for the disclosed subject matter, a video encoder and a video decoder in a streaming environment. The disclosed subject matter can be equally applicable to other video enabled applications, including, for example, video conferencing, digital TV, streaming services, storing of compressed video on digital media including CD, DVD, memory stick and the like, and so on.

The video processing system (100) includes a capture subsystem (113), that can include a video source (101), for example a digital camera, creating for example a stream of video pictures (102) that are uncompressed. In an example, the stream of video pictures (102) includes samples that are taken by the digital camera. The stream of video pictures (102), depicted as a bold line to emphasize a high data volume when compared to encoded video data (104) (or coded video bitstreams), can be processed by an electronic device (120) that includes a video encoder (103) coupled to the video source (101). The video encoder (103) can include hardware, software, or a combination thereof to enable or implement aspects of the disclosed subject matter as described in more detail below. The encoded video data (104) (or encoded video bitstream), depicted as a thin line to emphasize the lower data volume when compared to the stream of video pictures (102), can be stored on a streaming server (105) for future use. One or more streaming client subsystems, such as client subsystems (106) and (108) in FIG. 1 can access the streaming server (105) to retrieve copies (107) and (109) of the encoded video data (104). A client subsystem (106) can include a video decoder (110), for example, in an electronic device (130). The video decoder (110) decodes the incoming copy (107) of the encoded video data and creates an outgoing stream of video pictures (111) that can be rendered on a display (112) (e.g., display screen) or other rendering device (not depicted). In some streaming systems, the encoded video data (104), (107), and (109) (e.g., video bitstreams) can be encoded according to certain video coding/compression standards. Examples of those standards include ITU-T Recommendation H.265. In an example, a video coding standard under development is informally known as Versatile Video Coding (VVC). The disclosed subject matter may be used in the context of VVC.

It is noted that the electronic devices (120) and (130) can include other components (not shown). For example, the electronic device (120) can include a video decoder (not shown) and the electronic device (130) can include a video encoder (not shown) as well.

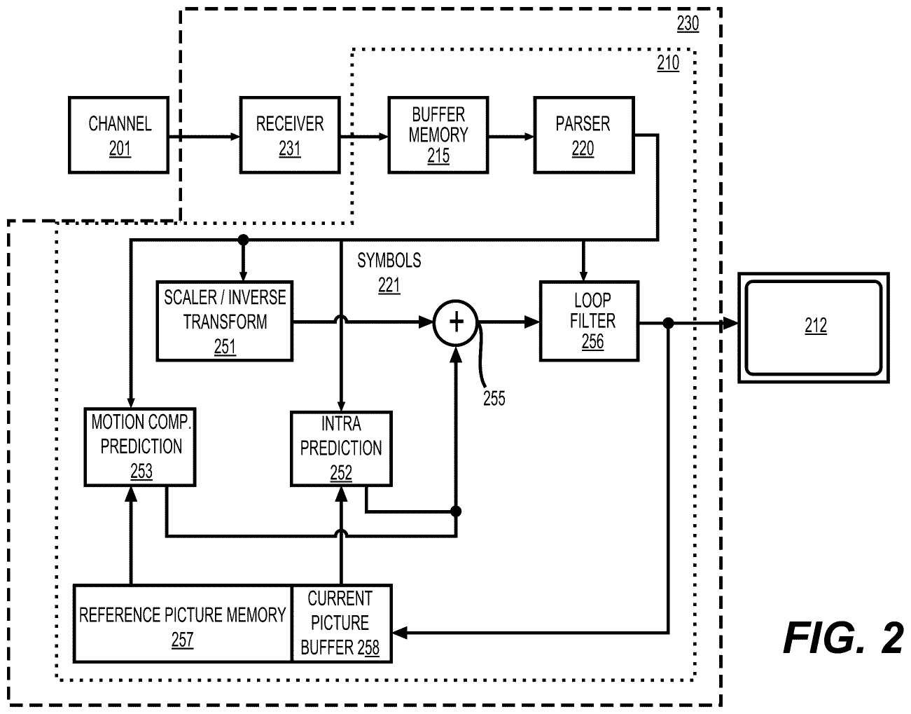

FIG. 2 shows an example of a block diagram of a video decoder (210). The video decoder (210) can be included in an electronic device (230). The electronic device (230) can include a receiver (231) (e.g., receiving circuitry). The video decoder (210) can be used in the place of the video decoder (110) in the FIG. 1 example.

The receiver (231) may receive one or more coded video sequences, included in a bitstream for example, to be decoded by the video decoder (210). In an aspect, one coded video sequence is received at a time, where the decoding of each coded video sequence is independent from the decoding of other coded video sequences. The coded video sequence may be received from a channel (201), which may be a hardware/software link to a storage device which stores the encoded video data. The receiver (231) may receive the encoded video data with other data, for example, coded audio data and/or ancillary data streams, that may be forwarded to their respective using entities (not depicted). The receiver (231) may separate the coded video sequence from the other data. To combat network jitter, a buffer memory (215) may be coupled in between the receiver (231) and an entropy decoder/parser (220) (“parser (220)” henceforth). In certain applications, the buffer memory (215) is part of the video decoder (210). In others, it can be outside of the video decoder (210) (not depicted). In still others, there can be a buffer memory (not depicted) outside of the video decoder (210), for example to combat network jitter, and in addition another buffer memory (215) inside the video decoder (210), for example to handle playout timing. When the receiver (231) is receiving data from a store/forward device of sufficient bandwidth and controllability, or from an isosynchronous network, the buffer memory (215) may not be needed, or can be small. For use on best effort packet networks such as the Internet, the buffer memory (215) may be required, can be comparatively large and can be advantageously of adaptive size, and may at least partially be implemented in an operating system or similar elements (not depicted) outside of the video decoder (210).

The video decoder (210) may include the parser (220) to reconstruct symbols (221) from the coded video sequence. Categories of those symbols include information used to manage operation of the video decoder (210), and potentially information to control a rendering device such as a render device (212) (e.g., a display screen) that is not an integral part of the electronic device (230) but can be coupled to the electronic device (230), as shown in FIG. 2. The control information for the rendering device(s) may be in the form of Supplemental Enhancement Information (SEI) messages or Video Usability Information (VUI) parameter set fragments (not depicted). The parser (220) may parse/entropy-decode the coded video sequence that is received. The coding of the coded video sequence can be in accordance with a video coding technology or standard, and can follow various principles, including variable length coding, Huffman coding, arithmetic coding with or without context sensitivity, and so forth. The parser (220) may extract from the coded video sequence, a set of subgroup parameters for at least one of the subgroups of pixels in the video decoder, based upon at least one parameter corresponding to the group. Subgroups can include Groups of Pictures (GOPs), pictures, tiles, slices, macroblocks, Coding Units (CUs), blocks, Transform Units (TUs), Prediction Units (PUs) and so forth. The parser (220) may also extract from the coded video sequence information such as transform coefficients, quantizer parameter values, motion vectors, and so forth.

The parser (220) may perform an entropy decoding/parsing operation on the video sequence received from the buffer memory (215), so as to create symbols (221).

Reconstruction of the symbols (221) can involve multiple different units depending on the type of the coded video picture or parts thereof (such as: inter and intra picture, inter and intra block), and other factors. Which units are involved, and how, can be controlled by subgroup control information parsed from the coded video sequence by the parser (220). The flow of such subgroup control information between the parser (220) and the multiple units below is not depicted for clarity.

Beyond the functional blocks already mentioned, the video decoder (210) can be conceptually subdivided into a number of functional units as described below. In a practical implementation operating under commercial constraints, many of these units interact closely with each other and can, at least partly, be integrated into each other. However, for the purpose of describing the disclosed subject matter, the conceptual subdivision into the functional units below is appropriate.

A first unit is the scaler/inverse transform unit (251). The scaler/inverse transform unit (251) receives a quantized transform coefficient as well as control information, including which transform to use, block size, quantization factor, quantization scaling matrices, etc. as symbol(s) (221) from the parser (220). The scaler/inverse transform unit (251) can output blocks comprising sample values, that can be input into aggregator (255).

In some cases, the output samples of the scaler/inverse transform unit (251) can pertain to an intra coded block. The intra coded block is a block that is not using predictive information from previously reconstructed pictures, but can use predictive information from previously reconstructed parts of the current picture. Such predictive information can be provided by an intra picture prediction unit (252). In some cases, the intra picture prediction unit (252) generates a block of the same size and shape of the block under reconstruction, using surrounding already reconstructed information fetched from the current picture buffer (258). The current picture buffer (258) buffers, for example, partly reconstructed current picture and/or fully reconstructed current picture. The aggregator (255), in some cases, adds, on a per sample basis, the prediction information the intra prediction unit (252) has generated to the output sample information as provided by the scaler/inverse transform unit (251).

In other cases, the output samples of the scaler/inverse transform unit (251) can pertain to an inter coded, and potentially motion compensated, block. In such a case, a motion compensation prediction unit (253) can access reference picture memory (257) to fetch samples used for prediction. After motion compensating the fetched samples in accordance with the symbols (221) pertaining to the block, these samples can be added by the aggregator (255) to the output of the scaler/inverse transform unit (251) (in this case called the residual samples or residual signal) so as to generate output sample information. The addresses within the reference picture memory (257) from where the motion compensation prediction unit (253) fetches prediction samples can be controlled by motion vectors, available to the motion compensation prediction unit (253) in the form of symbols (221) that can have, for example X, Y, and reference picture components. Motion compensation also can include interpolation of sample values as fetched from the reference picture memory (257) when sub-sample exact motion vectors are in use, motion vector prediction mechanisms, and so forth.

The output samples of the aggregator (255) can be subject to various loop filtering techniques in the loop filter unit (256). Video compression technologies can include in-loop filter technologies that are controlled by parameters included in the coded video sequence (also referred to as coded video bitstream) and made available to the loop filter unit (256) as symbols (221) from the parser (220). Video compression can also be responsive to meta-information obtained during the decoding of previous (in decoding order) parts of the coded picture or coded video sequence, as well as responsive to previously reconstructed and loop-filtered sample values.

The output of the loop filter unit (256) can be a sample stream that can be output to the render device (212) as well as stored in the reference picture memory (257) for use in future inter-picture prediction.

Certain coded pictures, once fully reconstructed, can be used as reference pictures for future prediction. For example, once a coded picture corresponding to a current picture is fully reconstructed and the coded picture has been identified as a reference picture (by, for example, the parser (220)), the current picture buffer (258) can become a part of the reference picture memory (257), and a fresh current picture buffer can be reallocated before commencing the reconstruction of the following coded picture.

The video decoder (210) may perform decoding operations according to a predetermined video compression technology or a standard, such as ITU-T Rec. H.265. The coded video sequence may conform to a syntax specified by the video compression technology or standard being used, in the sense that the coded video sequence adheres to both the syntax of the video compression technology or standard and the profiles as documented in the video compression technology or standard. Specifically, a profile can select certain tools as the only tools available for use under that profile from all the tools available in the video compression technology or standard. Also necessary for compliance can be that the complexity of the coded video sequence is within bounds as defined by the level of the video compression technology or standard. In some cases, levels restrict the maximum picture size, maximum frame rate, maximum reconstruction sample rate (measured in, for example megasamples per second), maximum reference picture size, and so on. Limits set by levels can, in some cases, be further restricted through Hypothetical Reference Decoder (HRD) specifications and metadata for HRD buffer management signaled in the coded video sequence.

In an aspect, the receiver (231) may receive additional (redundant) data with the encoded video. The additional data may be included as part of the coded video sequence(s). The additional data may be used by the video decoder (210) to properly decode the data and/or to more accurately reconstruct the original video data. Additional data can be in the form of, for example, temporal, spatial, or signal noise ratio (SNR) enhancement layers, redundant slices, redundant pictures, forward error correction codes, and so on.

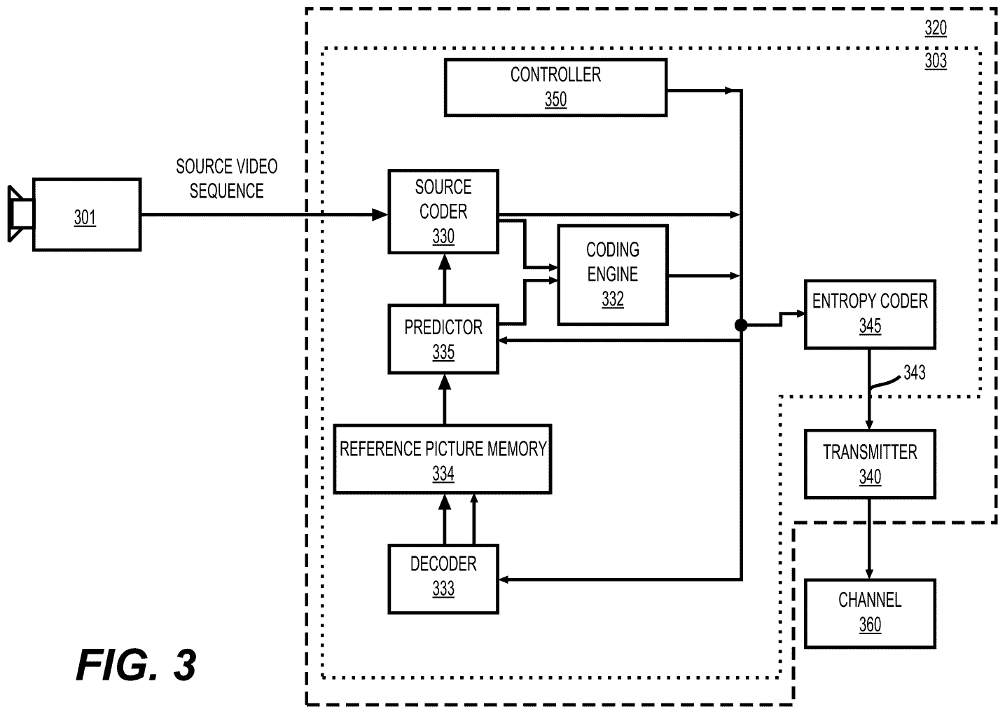

FIG. 3 shows an example of a block diagram of a video encoder (303). The video encoder (303) is included in an electronic device (320). The electronic device (320) includes a transmitter (340) (e.g., transmitting circuitry). The video encoder (303) can be used in the place of the video encoder (103) in the FIG. 1 example.

The video encoder (303) may receive video samples from a video source (301) (that is not part of the electronic device (320) in the FIG. 3 example) that may capture video image(s) to be coded by the video encoder (303). In another example, the video source (301) is a part of the electronic device (320).

The video source (301) may provide the source video sequence to be coded by the video encoder (303) in the form of a digital video sample stream that can be of any suitable bit depth (for example: 8 bit, 10 bit, 12 bit, . . . ), any colorspace (for example, BT.601 Y CrCB, RGB, . . . ), and any suitable sampling structure (for example Y CrCb 4:2:0, Y CrCb 4:4:4). In a media serving system, the video source (301) may be a storage device storing previously prepared video. In a videoconferencing system, the video source (301) may be a camera that captures local image information as a video sequence. Video data may be provided as a plurality of individual pictures that impart motion when viewed in sequence. The pictures themselves may be organized as a spatial array of pixels, wherein each pixel can comprise one or more samples depending on the sampling structure, color space, etc. in use. The description below focuses on samples.

According to an aspect, the video encoder (303) may code and compress the pictures of the source video sequence into a coded video sequence (343) in real time or under any other time constraints as required. Enforcing appropriate coding speed is one function of a controller (350). In some aspects, the controller (350) controls other functional units as described below and is functionally coupled to the other functional units. The coupling is not depicted for clarity. Parameters set by the controller (350) can include rate control related parameters (picture skip, quantizer, lambda value of rate-distortion optimization techniques, . . . ), picture size, group of pictures (GOP) layout, maximum motion vector search range, and so forth. The controller (350) can be configured to have other suitable functions that pertain to the video encoder (303) optimized for a certain system design.

In some aspects, the video encoder (303) is configured to operate in a coding loop. As an oversimplified description, in an example, the coding loop can include a source coder (330) (e.g., responsible for creating symbols, such as a symbol stream, based on an input picture to be coded, and a reference picture(s)), and a (local) decoder (333) embedded in the video encoder (303). The decoder (333) reconstructs the symbols to create the sample data in a similar manner as a (remote) decoder also would create. The reconstructed sample stream (sample data) is input to the reference picture memory (334). As the decoding of a symbol stream leads to bit-exact results independent of decoder location (local or remote), the content in the reference picture memory (334) is also bit exact between the local encoder and remote encoder. In other words, the prediction part of an encoder “sees” as reference picture samples exactly the same sample values as a decoder would “see” when using prediction during decoding. This fundamental principle of reference picture synchronicity (and resulting drift, if synchronicity cannot be maintained, for example because of channel errors) is used in some related arts as well.

The operation of the “local” decoder (333) can be the same as a “remote” decoder, such as the video decoder (210), which has already been described in detail above in conjunction with FIG. 2. Briefly referring also to FIG. 2, however, as symbols are available and encoding/decoding of symbols to a coded video sequence by an entropy coder (345) and the parser (220) can be lossless, the entropy decoding parts of the video decoder (210), including the buffer memory (215), and parser (220) may not be fully implemented in the local decoder (333).

In an aspect, a decoder technology except the parsing/entropy decoding that is present in a decoder is present, in an identical or a substantially identical functional form, in a corresponding encoder. Accordingly, the disclosed subject matter focuses on decoder operation. The description of encoder technologies can be abbreviated as they are the inverse of the comprehensively described decoder technologies. In certain areas a more detail description is provided below.

During operation, in some examples, the source coder (330) may perform motion compensated predictive coding, which codes an input picture predictively with reference to one or more previously coded picture from the video sequence that were designated as “reference pictures.” In this manner, the coding engine (332) codes differences between pixel blocks of an input picture and pixel blocks of reference picture(s) that may be selected as prediction reference(s) to the input picture.

The local video decoder (333) may decode coded video data of pictures that may be designated as reference pictures, based on symbols created by the source coder (330). Operations of the coding engine (332) may advantageously be lossy processes. When the coded video data may be decoded at a video decoder (not shown in FIG. 3), the reconstructed video sequence typically may be a replica of the source video sequence with some errors. The local video decoder (333) replicates decoding processes that may be performed by the video decoder on reference pictures and may cause reconstructed reference pictures to be stored in the reference picture memory (334). In this manner, the video encoder (303) may store copies of reconstructed reference pictures locally that have common content as the reconstructed reference pictures that will be obtained by a far-end video decoder (absent transmission errors).

The predictor (335) may perform prediction searches for the coding engine (332). That is, for a new picture to be coded, the predictor (335) may search the reference picture memory (334) for sample data (as candidate reference pixel blocks) or certain metadata such as reference picture motion vectors, block shapes, and so on, that may serve as an appropriate prediction reference for the new pictures. The predictor (335) may operate on a sample block-by-pixel block basis to find appropriate prediction references. In some cases, as determined by search results obtained by the predictor (335), an input picture may have prediction references drawn from multiple reference pictures stored in the reference picture memory (334).

The controller (350) may manage coding operations of the source coder (330), including, for example, setting of parameters and subgroup parameters used for encoding the video data.

Output of all aforementioned functional units may be subjected to entropy coding in the entropy coder (345). The entropy coder (345) translates the symbols as generated by the various functional units into a coded video sequence, by applying lossless compression to the symbols according to technologies such as Huffman coding, variable length coding, arithmetic coding, and so forth.

The transmitter (340) may buffer the coded video sequence(s) as created by the entropy coder (345) to prepare for transmission via a communication channel (360), which may be a hardware/software link to a storage device which would store the encoded video data. The transmitter (340) may merge coded video data from the video encoder (303) with other data to be transmitted, for example, coded audio data and/or ancillary data streams (sources not shown).

The controller (350) may manage operation of the video encoder (303). During coding, the controller (350) may assign to each coded picture a certain coded picture type, which may affect the coding techniques that may be applied to the respective picture. For example, pictures often may be assigned as one of the following picture types:

An Intra Picture (I picture) may be coded and decoded without using any other picture in the sequence as a source of prediction. Some video codecs allow for different types of intra pictures, including, for example Independent Decoder Refresh (“IDR”) Pictures.

A predictive picture (P picture) may be coded and decoded using intra prediction or inter prediction using a motion vector and reference index to predict the sample values of each block.

A bi-directionally predictive picture (B Picture) may be coded and decoded using intra prediction or inter prediction using two motion vectors and reference indices to predict the sample values of each block. Similarly, multiple-predictive pictures can use more than two reference pictures and associated metadata for the reconstruction of a single block.

Source pictures commonly may be subdivided spatially into a plurality of sample blocks (for example, blocks of 4×4, 8×8, 4×8, or 16×16 samples each) and coded on a block-by-block basis. Blocks may be coded predictively with reference to other (already coded) blocks as determined by the coding assignment applied to the blocks' respective pictures. For example, blocks of I pictures may be coded non-predictively or they may be coded predictively with reference to already coded blocks of the same picture (spatial prediction or intra prediction). Pixel blocks of P pictures may be coded predictively, via spatial prediction or via temporal prediction with reference to one previously coded reference picture. Blocks of B pictures may be coded predictively, via spatial prediction or via temporal prediction with reference to one or two previously coded reference pictures.

The video encoder (303) may perform coding operations according to a predetermined video coding technology or standard, such as ITU-T Rec. H.265. In its operation, the video encoder (303) may perform various compression operations, including predictive coding operations that exploit temporal and spatial redundancies in the input video sequence. The coded video data, therefore, may conform to a syntax specified by the video coding technology or standard being used.

In an aspect, the transmitter (340) may transmit additional data with the encoded video. The source coder (330) may include such data as part of the coded video sequence. Additional data may comprise temporal/spatial/SNR enhancement layers, other forms of redundant data such as redundant pictures and slices, SEI messages, VUI parameter set fragments, and so on.

A video may be captured as a plurality of source pictures (video pictures) in a temporal sequence. Intra-picture prediction (often abbreviated to intra prediction) makes use of spatial correlation in a given picture, and inter-picture prediction makes uses of the (temporal or other) correlation between the pictures. In an example, a specific picture under encoding/decoding, which is referred to as a current picture, is partitioned into blocks. When a block in the current picture is similar to a reference block in a previously coded and still buffered reference picture in the video, the block in the current picture can be coded by a vector that is referred to as a motion vector. The motion vector points to the reference block in the reference picture, and can have a third dimension identifying the reference picture, in case multiple reference pictures are in use.

In some aspects, a bi-prediction technique can be used in the inter-picture prediction. According to the bi-prediction technique, two reference pictures, such as a first reference picture and a second reference picture that are both prior in decoding order to the current picture in the video (but may be in the past and future, respectively, in display order) are used. A block in the current picture can be coded by a first motion vector that points to a first reference block in the first reference picture, and a second motion vector that points to a second reference block in the second reference picture. The block can be predicted by a combination of the first reference block and the second reference block.

Further, a merge mode technique can be used in the inter-picture prediction to improve coding efficiency.

According to some aspects of the disclosure, predictions, such as inter-picture predictions and intra-picture predictions, are performed in the unit of blocks. For example, according to the HEVC standard, a picture in a sequence of video pictures is partitioned into coding tree units (CTU) for compression, the CTUs in a picture have the same size, such as 64×64 pixels, 32×32 pixels, or 16×16 pixels. In general, a CTU includes three coding tree blocks (CTBs), which are one luma CTB and two chroma CTBs. Each CTU can be recursively quadtree split into one or multiple coding units (CUs). For example, a CTU of 64×64 pixels can be split into one CU of 64×64 pixels, or 4 CUs of 32×32 pixels, or 16 CUs of 16×16 pixels. In an example, each CU is analyzed to determine a prediction type for the CU, such as an inter prediction type or an intra prediction type. The CU is split into one or more prediction units (PUs) depending on the temporal and/or spatial predictability. Generally, each PU includes a luma prediction block (PB), and two chroma PBs. In an aspect, a prediction operation in coding (encoding/decoding) is performed in the unit of a prediction block. Using a luma prediction block as an example of a prediction block, the prediction block includes a matrix of values (e.g., luma values) for pixels, such as 8×8 pixels, 16×16 pixels, 8×16 pixels, 16×8 pixels, and the like.

It is noted that the video encoders (103) and (303), and the video decoders (110) and (210) can be implemented using any suitable technique. In an aspect, the video encoders (103) and (303) and the video decoders (110) and (210) can be implemented using one or more integrated circuits. In another aspect, the video encoders (103) and (303), and the video decoders (110) and (210) can be implemented using one or more processors that execute software instructions.

Some aspects of the disclosure provide techniques of transform kennel derivation in inter coded block with intra prediction mode information.

In some aspects, intra prediction information is available for inter coded blocks.

According to an aspect of the disclosure, intra and inter predictions can be suitably combined by coding techniques. One of the coding techniques to combine intra and inter prediction is referred to as combined inter and intra prediction (CIIP) that is also called a multi-hypothesis intra-inter prediction. For example, the CIIP can combine one intra prediction and one merge prediction. In an example, when a CU is in the merge mode, a specific flag for intra mode is signaled. When the specific flag is true, an intra mode can be selected from an intra candidate list. For luma component, the intra candidate list is derived from 4 intra prediction modes, such as DC mode, planar mode, horizontal mode, and vertical mode, and the size of the intra mode candidate list can be 3 or 4 depending on the block shape. In an example, when the CU width is larger than twice of CU height, the horizontal mode is removed from the intra mode candidate list and when the CU height is larger than twice of CU width, vertical mode is removed from the intra mode candidate list. In some embodiments, an intra prediction is performed based on an intra prediction mode selected by an intra mode index and an inter prediction is performed based on a merge index. The intra prediction and the inter prediction are combined using weighted average. For chroma component, a copy of the intra and/or inter prediction mode information from the luma component can be used without extra signaling in some examples.

In some embodiments, the weights for combining the intra prediction and the inter prediction can be suitably determined. In an example, when DC or planar mode is selected or the coding block (CB) width or height is smaller than 4, equal weights are applied for inter prediction and intra prediction. In another example, for a CB with CB width and height larger than or equal to 4, when horizontal/vertical mode is selected, the CB is first vertically/horizontally split into four equal-area regions. Each region has a weight set, denoted as (w_intraᵢ, w_interᵢ), where i is from 1 to 4. In an example, the first weight set (w_intra₁, w_inter₁)=(6, 2), the second weight set (w_intra₂, w_inter₂)=(5, 3), the third weight set (w_intra₃, w_inter₃)=(3, 5), and fourth weight set (w_intra₄, w_inter₄)=(2, 6), can be applied to a corresponding region. For example, the first weight set (w_intra₁, w_inter₁) is for the region closest to the reference samples and fourth weight set (w_intra₄, w_inter₄) is for the region farthest away from the reference samples. Then, the combined prediction can be calculated by summing up the two weighted predictions and right-shifting 3 bits.

Moreover, the intra prediction mode for the intra hypothesis of predictors can be saved for the intra mode coding of the following neighboring CBs when the neighboring CBs are intra coded.

According to another aspect of the disclosure, an inter coded block can be partitioned into two or more partitions. The two or more partitions can be predicted by different prediction information. In an example, one partition can be predicted by inter prediction, and another partition can be predicted by intra prediction. In another example, the two or more partitions can be predicted by inter predictions of different motion information.

In some examples (e.g., VVC), a technique that is referred to as geometric partition mode (GPM) is used. Specifically, in VVC, GPM is used for inter prediction block. In an example, the GPM is only applied to CUs that are 8×8 or larger. The GPM can be signaled using a CU-level flag as one kind of merge modes, with other merge modes, such as a regular merge mode, a merge with motion vector difference (MMVD) mode, a combined inter and intra prediction (CIIP) mode and a subblock merge mode.

When the GPM mode is used on a CU, the CU is split by a partition edge into two geometric-shaped partitions using one of a plurality of partitioning manners. In some examples, 64 different partitioning manners are used. The partitioning manners can be differentiated by 24 angles (non-uniformed quantized between 0 and 360°) and up to 4 edges relative to the center of the CU for each angle. The partition edge is a line that intersects boundaries of the CU and splits the CU into two partitions.

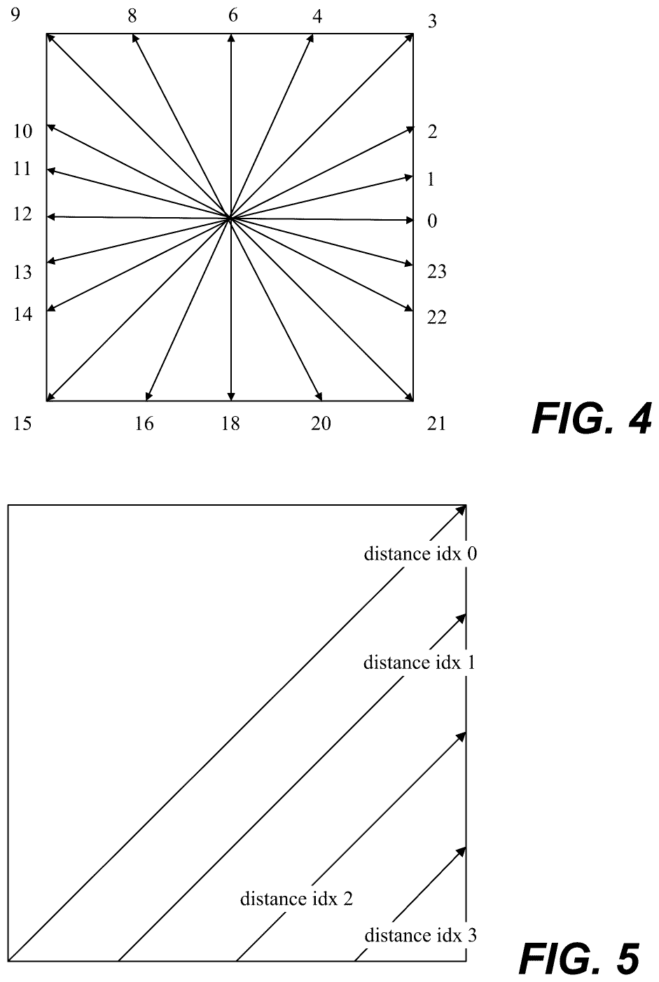

FIG. 4 shows a diagram of 24 angles that are used in the GPM in some examples. The angles can be identified using angle indices, such as angle index 0 to angle index 23 in some examples.

FIG. 5 shows a diagram of possible partition edges for the angle index 3 in an example. In FIG. 5, four possible partition edges can be associated with the angle index 3. It is noted that, for some angle indices, three possible partition edges may be associated with each angle index.

In some examples, each geometric partition in the CU is inter-predicted using its own motion. In an example, only uni-prediction is allowed for each partition, that is, each partition has one motion vector and one reference picture index. The uni-prediction motion constraint is applied to ensure that, similar to bi-prediction, two motion compensated predictions are used for each CU.

In some examples, when the GPM is used for the current CU, then a signal indicating the geometric partition index (e.g., indicating an angle and an edge), and two merge indices (one for each partition) are further signalled. In an example, the number of maximum GPM candidate size is signalled explicitly at slice level and specifies syntax binarization for GPM merge indices.

It is also noted that, in some examples, the two partitions of an inter coded block can be respectively coded by inter prediction and intra prediction. The information of the intra prediction can be regarded as the intra prediction information associated with the inter coded block.

It is also noted that in some codecs, a buffer is used to store intra prediction information of CUs. For each CU, no matter the CU is inter coded or intra coded, intra prediction information is derived and stored in the buffer. The intra prediction information in the buffer can be used for transform kernel derivation in some examples. The transform kernel derivation can be used for primary transform and/or secondary transform.

In some codec examples (e.g., VVC), multiple transform types, such as type-2 DCT (DCT-2), type-7 DST (DST-7), type-8 DCT (DCT-8), and the like can be used in the primary transform. In some examples, techniques that are referred to as multiple transform selection (MTS) can be used. In an example, an explicit MTS can use a signal to explicitly indicate a selection of a transform kernel. In another example, an implicit MTS can implicitly derive a selection of a transform kernel. In some aspects, the explicit MTS can be applied to both intra and inter coded blocks, while the implicit MTS can be used only for intra coded blocks. In an aspect, in the explicit MTS, the choice of DST-7/DCT-8 is indicated by explicit signaling of the transform type. In another aspect, in implicit MTS, the transform type is selected based on coded information that is known to both the encoder and decoder, and transform type signaling is not needed.

In some examples, in the explicit MTS, the index (e.g., denoted by mts_idx) is signaled at the end of CU level syntax to indicate the transform type for horizontal transform and vertical transform. In an example, the value of mts_idx ranges from 0 to 4. For example, value 0 of mts_idx indicates a use of DCT-2 for horizontal transform and vertical transform; value 1 of mts_idx indicates a use of DST-7 for horizontal transform and vertical transform; value 2 of mts_idx indicates a use of DCT-8 for horizontal transform and DST-7 for vertical transform; value 3 of mts_idx indicates a use of DST-7 for horizontal transform and DCT-8 for vertical transform; and value 4 of mts_idx indicates a use of DCT-8 for horizontal transform and vertical transform.

In some examples, secondary transform can be applied following the primary transform. For example, low-frequency non-separable transform (LFNST) is a non-separable transform that can be applied to the top-left low-frequency region of primary transform coefficients. In some examples (e.g., VVC), the LFNST can be applied for intra coded blocks that use DCT-2 as the primary transform. The transform kernels defined in LFNST can include multiple transform sets, such as 4 transform sets in VVC. In some examples, a selection of a transform set from the four LFNST sets (e.g., denoted by lfnstSetIdx), depends on the intra prediction mode (e.g., denoted by intraPredMode).

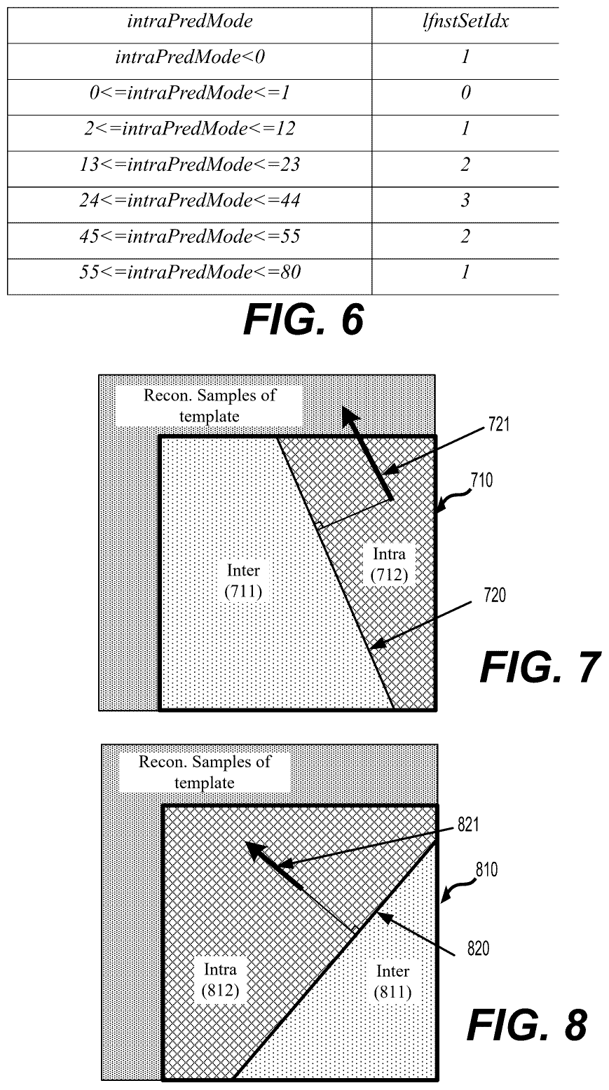

FIG. 6 shows an example of a table that maps LFNST sets to intra prediction modes.

Aspects of the present disclosure provide techniques for video compression, including transform kernel derivation of inter coded block with intra prediction mode information. For example, for a current block in a current picture coded at least partially using an inter prediction mode that generates prediction samples based on a reference picture that is different form a current picture, an intra prediction mode associated with the current block in the current picture is obtained. One or more transform kernels can be determined based on the intra prediction mode associated with the current block. The current block is encoded/decoded based on the one or more transform kernels.

In some aspects, primary transform kernel(s) or non-primary transform kernel(s) (e.g., secondary transform kernel(s)) for a block in the combined inter and intra prediction (CIIP) mode can be derived based on intra prediction mode information of the block. When a block is in the CIIP mode, the block can be predicted based on a combination of inter prediction information of the block and intra prediction information of the block. The transform kernel(s) can be derived based on the intra prediction information of the block.

In some embodiments, the intra prediction mode of the block in the CIIP mode that is used for generating the intra-prediction part of the block is used to derive the transform kernel(s). It is noted that the intra prediction mode of the block in the CIIP mode for deriving the transform kernel(s) can be obtained by any suitable technique. In an example, the intra prediction mode is a predefined intra prediction mode. In another example, the intra prediction mode is a signaled intra prediction mode. In another example, the intra prediction mode is a decoder-side derived intra prediction mode.

It is also noted that any suitable method that can derive the primary or non-primary kernel(s) based on the intra prediction mode information can be used to derive the primary or non-primary transform kernels of the block in the CIIP mode.

In some examples, the methods that derive the primary or non-primary transform kernel derivation using intra prediction mode information of intra coded blocks can be used to derive the primary or non-primary transform kernel(s) by of the blocks in the CIIP mode using the intra prediction mode information of the blocks in the CIIP mode. For example, the table in FIG. 6 can be used to derive secondary transform kernel(s) of blocks in the CIIP mode based on intra prediction information of the blocks in the CIIP mode.

In some embodiments, the intra prediction mode is derived by comparing the template costs (e.g., SAD, SATD and the like) of candidate intra prediction modes of the block in the CIIP mode. The derived intra prediction mode is used to determine the primary or non-primary transform kernel(s) using a pre-defined mapping table. In an example, the pre-defined mapping table maps various intra prediction modes to primary transform kernel(s) and/or secondary transform kernel(s).

In an example, for a candidate intra prediction mode, the candidate intra prediction mode is applied to a template (e.g., one or more rows of neighboring samples above the current block, one or more columns of neighboring samples left to the current block, a combination of a row of neighboring samples above the current block and a column of neighboring samples left to the current block, a L-shape area of neighboring samples to the up-left corner of the current block) of the current block to derive candidate reconstructed samples of the template. In an example, the candidate reconstructed samples of the template can be compared with the reconstructed samples of the template (the template has been reconstructed at the time of reconstructing the current block) to calculate the sum of absolute differences (SAD) as the template cost of SAD of the candidate intra prediction mode.

In another example, sum of absolute transformed differences (SATD) is calculated based on the candidate reconstructed samples of the template and the reconstructed samples of the template. For example, a Hadamard transform is applied to the differences of the candidate reconstructed samples of the template and the reconstructed samples of the template to obtain transform coefficients in the frequency domain, and SATD is calculated based on the transform coefficients in the frequency domain as the template cost of SATD of the candidate intra prediction mode.

In an example, based on the template costs (e.g., SAD, SATD, and the like) of the candidate intra prediction modes, the candidate intra prediction mode with the least template cost is used to as the intra prediction mode to select a transform set (e.g., primary and/or non primary transform kernel(s)) using the pre-defined mapping table.

In an aspect, a list of candidate intra prediction modes with ranked template costs (e.g. SAD, SATD, and the like) is derived according to the template costs of the candidate intra prediction modes. Then, one of the candidate intra prediction modes in the list is selected and used to determine a transform set (e.g., primary transform kernel(s), secondary transform kernel(s), and the like) using the pre-defined mapping table. In an example, the one of the candidate intra prediction modes that is selected can be signaled with a syntax (such as an index indicative of the one in the list) in a bitstream.

In another example, the selected candidate intra prediction mode in the list is implicitly determined by comparing other cost metrics between the candidate intra prediction modes in the list. In an example, mean removal SAD cost values are calculated for the first two candidate intra prediction modes in the list, and the one with the lower mean removal SAD cost value can be used to select a transform set (e.g., primary and/or non primary transform kernel(s)) using the pre-defined mapping table.

In some embodiments, the intra prediction mode is derived by comparing the occurrences of neighboring blocks with intra prediction modes in a pre-defined area neighboring to the current block in the CIIP mode. The derived intra prediction mode is used to determine the transform(s) kernel (e.g., primary transform kernel(s), secondary transform kernel(s) and the like), such as according to the pre-defined mapping table.

In some examples, the intra prediction mode with the most frequent occurrence in the pre-defined area neighboring to the current block is used to select the transform kernel (e.g., primary transform kernel(s), secondary transform kernel(s) and the like).

In some examples, a list of intra prediction modes with ranked occurrences in the pre-defined area neighboring to the current block is derived. One of the intra prediction modes in the list is used to determine the transform(s) kernel (e.g., primary transform kernel(s), secondary transform kernel(s) and the like), such as according to the pre-defined mapping table. In an example, the used intra prediction mode (to determine the transform kernel) can be signaled with a syntax (such as an index indicative of the used intra prediction mode in the list) in a bitstream.

In another example, the used intra prediction mode is implicitly determined by comparing other cost metrics (e.g., template costs and the like) between the intra prediction modes in the list.

In some embodiments, a decoder-side intra prediction mode derivation method is used to derive the transform kernel when a specified intra prediction mode is used in the CIIP mode.

In an example, the specified intra prediction mode is planar mode. For example, when the planar mode is used in the CIIP mode for reconstruction of the current block in the CIIP mode, the decoder-side intra prediction mode derivation method is used to derive an intra prediction mode for the current block, and the derived intra prediction mode is used to derive the transform kernel (e.g., the primary kernel(s), the secondary transform kernel(s), and the like) using the pre-defined mapping table.

In another example, the specified intra prediction mode is planar horizontal mode or planar vertical mode. For example, when planar horizontal mode or planar vertical mode is used in the CIIP mode for reconstruction of the current block in the CIIP mode, the decoder-side intra prediction mode derivation method is used to derive an intra prediction mode for the current block, and the derived intra prediction mode is used to derive the transform kernel (e.g., the primary kernel(s), the secondary transform kernel(s), and the like) using the pre-defined mapping table.

In another example, the specified intra prediction mode is DC mode. For example, when DC mode is used in the CIIP mode for reconstruction of the current block in the CIIP mode, the decoder-side intra prediction mode derivation method is used to derive an intra prediction mode for the current block, and the derived intra prediction mode is used to derive the transform kernel (e.g., the primary kernel(s), the secondary transform kernel(s), and the like) using the pre-defined mapping table.

In some embodiments, a pre-defined intra mode (e.g., planar mode) is used to determine the transform kernel. For example, when the current block is coded in the CIIP mode, no matter the intra prediction mode used in the reconstruction of the current block, a predefined intra prediction mode is used to derive the transform kernel (e.g., the primary kernel(s), the secondary transform kernel(s), and the like) using the pre-defined mapping table.

In some aspects, primary transform kernel(s) or non-primary transform kernel(s) (e.g., secondary transform kernel(s)) for a block in the GPM mode can be derived based on intra prediction mode information associated with the block. When a block is in the GPM mode, the block is further partitioned with non-rectangular boundary into two parts, such as a first part and a second part. In some examples, the first part is inter predicted and the second part is intra predicted. In an example, the primary transform kernel(s) or non-primary transform kernel(s) (e.g., secondary transform kernel(s)) for the block in the GPM mode can be derived based on intra prediction mode information associated with the second part.

In some embodiments, the intra prediction mode used for generating the intra-prediction signal is used to determine the transform kernel. For example, the block in the GPM mode includes a first part that is inter prediction, and a second part that is intro predicted based on an intra prediction mode. The intra prediction mode of the second part of the block in the GPM mode is used to derive the transform kernel(s). It is noted that the intra prediction mode of second part for deriving the transform kernel(s) can be obtained by any suitable technique. In an example, the intra prediction mode is a predefined intra prediction mode. In another example, the intra prediction mode is a signaled intra prediction mode. In another example, the intra prediction mode is a decoder-side derived intra prediction mode.

It is also noted that any suitable method that can derive the primary or non-primary kernel(s) based on the intra prediction mode information can be used to derive the primary or non-primary transform kernels of the block in the GPM mode.

In some examples, the methods that derive the primary or non-primary transform kernel derivation using intra prediction mode information of intra coded blocks can be used to derive the primary or non-primary transform kernel(s) by of the blocks in the GPM mode using the intra prediction mode information of the blocks in the GPM mode. For example, the table in FIG. 6 can be used to derive secondary transform kernel(s) of blocks in the GPM mode based on intra prediction information of (e.g., the intra coded part of) the blocks in the GPM mode.

In some embodiments, the intra prediction mode is derived by comparing the template costs (e.g., SAD, SATD and the like) of candidate intra prediction modes of the block in the GPM mode. The derived intra prediction mode is used to determine the primary or non-primary transform kernel(s) using a pre-defined mapping table. In an example, the pre-defined mapping table maps various intra prediction modes to primary transform kernel(s) and/or secondary transform kernel(s).

In an example, based on the template costs (e.g., SAD, SATD, and the like) of the candidate intra prediction modes, the candidate intra prediction mode with the least template cost is used as the intra prediction mode associated with the current block to select a transform set (e.g., primary and/or non primary transform kernel(s)) using the pre-defined mapping table.

In an aspect, a list of candidate intra prediction modes with ranked template costs (e.g. SAD, SATD, and the like) is derived according to the template costs of the candidate intra prediction modes. Then, one of the candidate intra prediction modes in the list is selected and used to determine a transform set (e.g., primary transform kernel(s), secondary transform kernel(s), and the like) using the pre-defined mapping table. In an example, the one of the candidate intra prediction modes that is selected can be signaled with a syntax (such as an index indicative of the one in the list) in a bitstream.

In another example, the selected candidate intra prediction mode in the list is implicitly determined by comparing other cost metrics between the candidate intra prediction modes in the list. In an example, mean removal SAD cost values are calculated for the first two candidate intra prediction modes in the list, and the one with the lower mean removal SAD cost value can be used to select a transform set (e.g., primary and/or non primary transform kernel(s)) using the pre-defined mapping table.

In some examples, a block in the GPM mode can have multiple candidate LFNST/NSPT transform kernel sets. In some examples, multiple candidate intra prediction modes are associated with the block in the GPM mode, the multiple candidate intra prediction modes respectively map to different LFNST/NSPT transform kernel sets. A syntax can be signaled to indicate which candidate intra prediction mode is used to determine the LFNST/NSPT transform kernel set to use in the encoding/decoding. For example, two candidate intra prediction modes are determined to be associated with the block in the GPM mode, the two candidate intra prediction modes can be suitably ordered in a list, and then a flag (1 bit) at the block level can be signaled in the bitstream to indicate which one in the list is used to determine the mapped LFNST/NSPT transform kernel set for encoding/decoding the block.

In some embodiments, the intra prediction mode is derived by comparing the occurrences of neighboring blocks with intra prediction modes in a pre-defined area neighboring to the current block in the GPM mode. The derived intra prediction mode is used to determine the transform(s) kernel (e.g., primary transform kernel(s), secondary transform kernel(s) and the like), such as according to the pre-defined mapping table.

In some examples, the intra prediction mode with the most frequent occurrence in the pre-defined area neighboring to the current block is used to select the transform kernel (e.g., primary transform kernel(s), secondary transform kernel(s) and the like).

In some examples, a list of intra prediction modes with ranked occurrences in the pre-defined area neighboring to the current block is derived. One of the intra prediction modes in the list is used to determine the transform(s) kernel (e.g., primary transform kernel(s), secondary transform kernel(s) and the like), such as according to the pre-defined mapping table. In an example, the used intra prediction mode (to determine the transform kernel) can be signaled with a syntax (such as an index indicative of the used intra prediction mode in the list) in a bitstream.

In another example, the used intra prediction mode is implicitly determined by comparing other cost metrics (e.g., template costs and the like) between the intra prediction modes in the list.

In some embodiments, an intra prediction mode specific to the GPM mode with two partitions is used to determine the transform kernel.

In an example, a parallel intra (prediction) mode associated with the partition boundary is used, such as shown in FIG. 7.

FIG. 7 shows a diagram of a current block (710) in some examples. The current block (710) is coded in the GPM mode. The current block (710) is partition into a first part (711) and a second part (712) by a partition boundary (720). The first part (711) is inter coded and the second part (712) is intra coded. In the FIG. 7 example, an intra prediction mode can be determined based on the partition boundary (720), for example having an angle parallel to the partition boundary (720), as indicated by a directional line (721). The intra prediction mode corresponding to the directional line (721) can be referred to as parallel intra mode of the block (710) in the GPM mode.

It is noted that in some examples, the parts in the block of the GPM mode can have both intra coded parts or both inter coded parts. For example, the block in the GPM mode is partition into a first part and a second part by a partition boundary. The first part is inter coded with first motion information and the second part is inter coded with second motion information that is different from the first motion information. A parallel intra (prediction) mode can be derived according to the partition boundary, and the parallel intra (prediction) mode can be used to determine the transform(s) kernel (e.g., primary transform kernel(s), secondary transform kernel(s) and the like), such as according to the pre-defined mapping table.

In another example, a perpendicular intra mode associated with the partition boundary is used, such as shown in FIG. 8.

FIG. 8 shows a diagram of a current block (810) in some examples. The current block (810) is coded in the GPM mode. The current block (810) is partition into a first part (811) and a second part (812) by a partition boundary (820). The first part (811) is inter coded and the second part (812) is intra coded. In the FIG. 8 example, an intra prediction mode can be determined based on the partition boundary (820), for example having an angle perpendicular to the partition boundary (820), as indicated by a directional line (821). The intra prediction mode corresponding to the directional line (821) can be referred to as perpendicular intra mode of the block (810) in the GPM mode.

It is noted that in some examples, the parts in the block of the GPM mode can have both intra coded parts or both inter coded parts. For example, the block in the GPM mode is partition into a first part and a second part by a partition boundary. The first part is inter coded with first motion information and the second part is inter coded with second motion information that is different from the first motion information. A perpendicular intra (prediction) mode can be derived according to the partition boundary, and the perpendicular intra (prediction) mode can be used to determine the transform(s) kernel (e.g., primary transform kernel(s), secondary transform kernel(s) and the like), such as according to the pre-defined mapping table.

In some embodiment, a pre-defined intra mode (e.g., planar mode) is used to determine the transform set (e.g., primary transform kernel(s) and/or secondary transform kernel(s)). For example, when the current block is coded in the GPM mode, no matter the angle of the partition boundary direction or the intra prediction mode used in the reconstruction of a part of the current block, a predefined intra prediction mode (e.g., planar mode) is used to derive the transform kernel (e.g., the primary kernel(s), the secondary transform kernel(s), and the like) using the pre-defined mapping table.

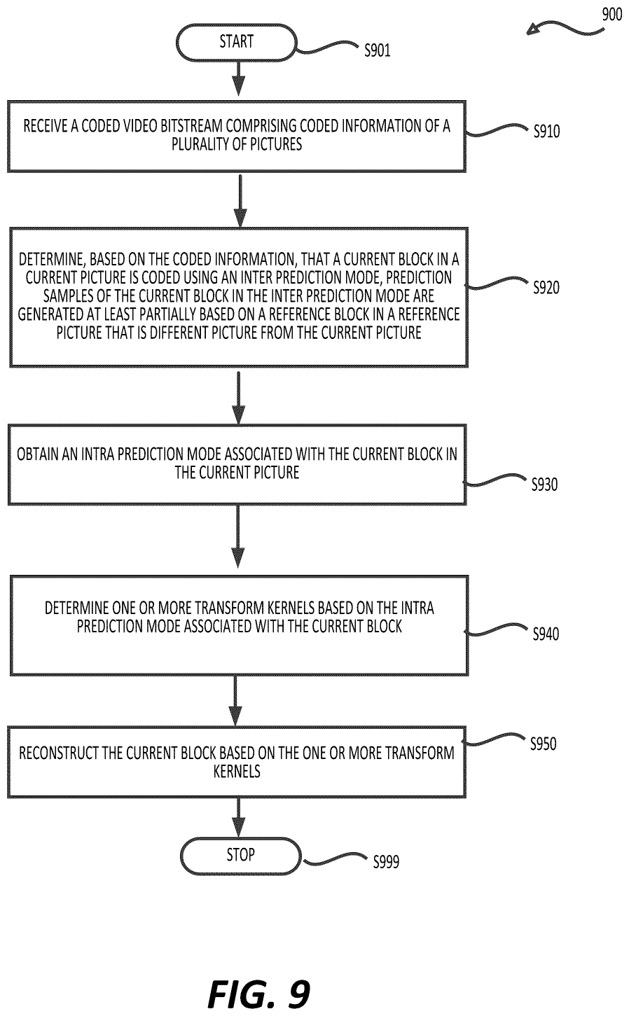

FIG. 9 shows a flow chart outlining a process (900) according to an aspect of the disclosure. The process (900) can be used in a video decoder. In various aspects, the process (900) is executed by processing circuitry, such as the processing circuitry that performs functions of the video decoder (110), the processing circuitry that performs functions of the video decoder (210), and the like. In some aspects, the process (900) is implemented in software instructions, thus when the processing circuitry executes the software instructions, the processing circuitry performs the process (900). The process starts at (S901) and proceeds to (S910).

At (S910), a coded video bitstream is received. The coded video bitstream includes coded information of a plurality of pictures.

At (S920), based on the coded information, a current block in a current picture is determined to be coded using an inter prediction mode, prediction samples of the current block in the inter prediction mode are generated at least partially based on a reference block in a reference picture that is different from the current picture.

At (S930), an intra prediction mode associated with the current block in the current picture is obtained.

At (S940), one or more transform kernels are determined based on the intra prediction mode associated with the current block.

At (S950), the current block is reconstructed based on the one or more transform kernels.

In some examples, transform coefficients of the current block are decoded from the coded information. One or more inverse transforms are applied on the transform coefficients based on the one or more transform kernels to calculate residual values for samples in the current block. The samples of the current block are reconstructed based on the residual values and a prediction of the current block, the prediction of the current block being at least partially based on the reference block in the reference picture.

In some examples, the current block is coded in at least one of a combined inter and intra prediction (CIIP) mode and a geometric partition mode (GPM). When the current block is coded in a combined inter and intra prediction (CIIP) mode, the CIIP mode includes the intra prediction mode for generating an intra prediction part of the prediction samples. When the current block is coded in a geometric partition mode (GPM), a partition of the current block is coded in the intra prediction mode.

In some examples, the one or more transform kernels are determined according to a predefined mapping table that maps the intra prediction mode to the one or more transform kernels.

In an example, the intra prediction mode is a predefined intra prediction mode. In another example, the intra prediction mode is a signaled intra prediction mode, for example obtained based on a signal in the coded video bitstream that indicates the intra prediction mode. In another example, the intra prediction mode is obtained according to a decoder-side derived intra prediction mode.

In some examples, template cost values are calculated respectively for a plurality of candidate intra prediction modes. The intra prediction mode with a least template cost value is selected from the plurality of candidate intra prediction modes.

In some examples, template cost values are calculated respectively for a plurality of candidate intra prediction modes. A list is formed. The list includes two or more candidate intra prediction modes of the plurality of candidate intra prediction modes according to the template cost values, the two or more candidate intra prediction modes are ordered in the list according to the template cost values. The intra prediction mode is selected from the list. In an example, a syntax is decoded from the coded video bitstream, the syntax indicates an index in the list, the intra prediction mode is selected from the list according to the syntax.

In another example, second cost values (different from the template cost values) are calculated respectively for the two or more candidate intra prediction modes in the list. The intra prediction mode is selected from the list based on the second cost values.

In an example, a first candidate intra prediction mode and a second candidate intra prediction mode are ordered. A flag is decoded from the coded video bitstream. One of the first candidate intra prediction mode and the second candidate intra prediction mode is selected as the intra prediction mode based on the flag.

The one or more transform kernels can include any of one or more primary transform kernels, one or more secondary transform kernels, one or more low-frequency non-separable transform (LFNST) kernels and/or one or more non-separable primary transform kernels.

In some examples, occurrence numbers of used intra prediction modes by neighboring blocks in a predefined area of the current block are counted. The intra prediction mode of a most frequency occurrence number is selected from the used intra prediction modes.

In some examples, occurrence numbers of used intra prediction modes by neighboring blocks in a predefined area of the current block are counted. A list including two or more used intra prediction modes of the used intra prediction modes is formed according to the occurrence numbers, the two or more used intra prediction modes are ordered in the list according to the occurrence numbers. The intra prediction mode is selected from the list.

In an example, a syntax is decoded from the coded video bitstream, the syntax indicates an index in the list, and the intra prediction mode is selected from the list according to the syntax. In another examples, cost values respectively for the two or more used intra prediction modes in the list are calculated. The intra prediction mode from the list based on the second cost values.

In some examples, the intra prediction mode is derived according to a decoder side intra prediction mode derivation when the current block is coded using at least one of a planar mode, a planar horizontal mode, a planar vertical mode, a DC mode and/or a pre-defined intra mode.

In some examples, the current block is coded in a geometric partition mode (GPM). The intra prediction mode is determined with an angle that is parallel or perpendicular to a partition boundary of the current block.

Then, the process proceeds to (S999) and terminates.

The process (900) can be suitably adapted. Step(s) in the process (900) can be modified and/or omitted. Additional step(s) can be added. Any suitable order of implementation can be used.

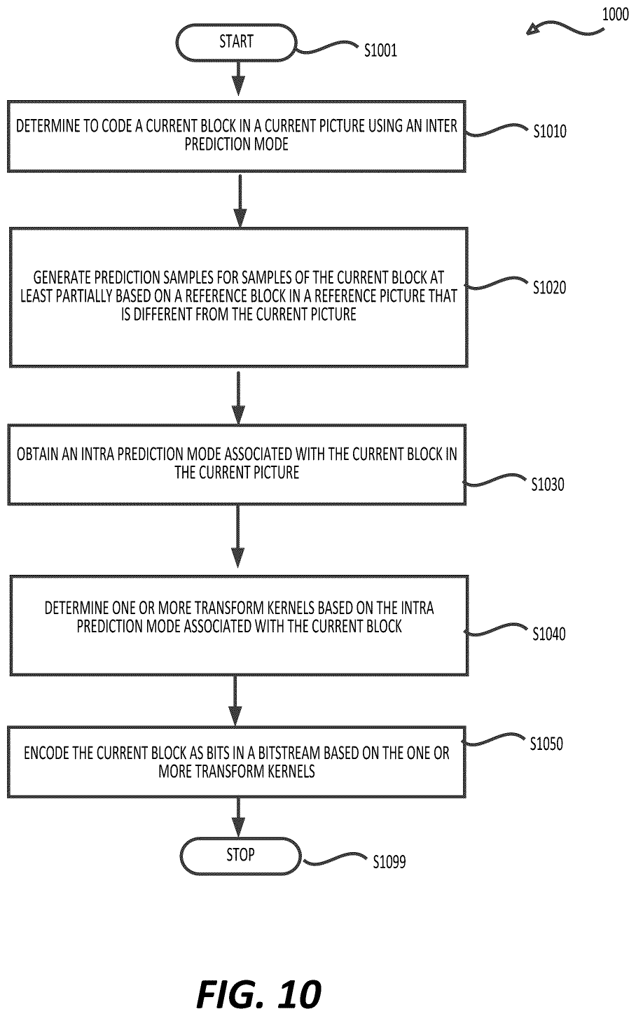

FIG. 10 shows a flow chart outlining a process (1000) according to an aspect of the disclosure. The process (1000) can be used in a video encoder. In various aspects, the process (1000) is executed by processing circuitry, such as the processing circuitry that performs functions of the video encoder (103), the processing circuitry that performs functions of the video encoder (303), and the like. In some aspects, the process (1000) is implemented in software instructions, thus when the processing circuitry executes the software instructions, the processing circuitry performs the process (1000). The process starts at (S1001) and proceeds to (S1010).

At (S1010), to code a current block in a current picture using an inter prediction mode is determined.

At (S1020), prediction samples for samples of the current block are generated at least partially based on a reference block in a reference picture that is different from the current picture.

At (S1030), an intra prediction mode associated with the current block in the current picture is obtained.

At (S1040), one or more transform kernels are determined based on the intra prediction mode associated with the current block.

At (S1050), the current block is encoded as bits in a bitstream based on the one or more transform kernels.

In some examples, one or more transforms are applied on residual values of the samples in the current block according to the one or more transform kernels to calculate transform coefficients, the residual values are calculated based on prediction samples and original values of the samples in the current block. The transform coefficients are encoded as bits in the bitstream.

In some examples, the inter prediction mode is at least one of a combined inter and intra prediction (CIIP) mode and a geometric partition mode (GPM). When the current block is coded in a combined inter and intra prediction (CIIP) mode, the CIIP mode includes the intra prediction mode for generating an intra prediction part of the prediction samples. When the current block is coded in a geometric partition mode (GPM), a partition of the current block is coded in the intra prediction mode.

In some examples, the one or more transform kernels are determined according to a predefined mapping table that maps the intra prediction mode to the one or more transform kernels.

In an example, the intra prediction mode is a predefined intra prediction mode. In another examples, the intra prediction mode is obtained according to a decoder-side derived intra prediction mode.

In some examples, a syntax indicative of the intra prediction mode is encoded as one or more bits in the bitstream.

In some examples, template cost values are calculated respectively for a plurality of candidate intra prediction modes. From the plurality of candidate intra prediction modes, the intra prediction mode with a least template cost value is determined.

In some examples, template cost values are calculated respectively for a plurality of candidate intra prediction modes. A list including two or more candidate intra prediction modes of the plurality of candidate intra prediction modes is formed according to the template cost values, the two or more candidate intra prediction modes are ordered in the list according to the template cost values. The intra prediction mode is selected from the list.

In some examples, a syntax is encoded as one or more bits om bitstream, the syntax indicates an index of the intra prediction mode in the list.

In some examples, second cost values are calculated respectively for the two or more candidate intra prediction modes in the list, and the intra prediction mode is selected from the list based on the second cost values.

In an example, one of a first candidate intra prediction mode and a second candidate intra prediction mode is selected as the intra prediction mode. A flag is encoded in the bitstream, the flag indicates the one of the first candidate intra prediction mode and the second candidate intra prediction mode.

In some examples, the one or more transform kernels include any of one or more primary transform kernels, one or more secondary transform kernel, one or more low-frequency non-separable transform (LFNST) kernels and/or one or more non-separable primary transform kernels.

In some examples, occurrence numbers of used intra prediction modes by neighboring blocks in a predefined area of the current block are counted. From the used intra prediction modes, the intra prediction mode of a most frequency occurrence number is selected.

In some examples, occurrence numbers of used intra prediction modes by neighboring blocks in a predefined area of the current block are counted. A list including two or more used intra prediction modes of the used intra prediction modes is formed according to the occurrence numbers, the two or more used intra prediction modes are ordered in the list according to the occurrence numbers. The intra prediction mode is selected from the list.

In an example, a syntax is encoded as one or more bits om bitstream, the syntax indicates an index of the intra prediction mode selected from the list.

In another examples, cost values are calculated respectively for the two or more used intra prediction modes in the list, the intra prediction mode is selected from the list based on the cost values.

In some examples, the intra prediction mode is derived according to a decoder side intra prediction mode derivation when the current block is coded using at least one of a planar mode, a planar horizontal mode, a planar vertical mode, a DC mode and/or a pre-defined intra mode.

In some examples, the current block is coded in a geometric partition mode (GPM). The intra prediction mode is determined with an angle that is parallel or perpendicular to a partition boundary of the current block.

Then, the process proceeds to (S1099) and terminates.

The process (1000) can be suitably adapted. Step(s) in the process (1000) can be modified and/or omitted. Additional step(s) can be added. Any suitable order of implementation can be used.

According to an aspect of the disclosure, a method of processing visual media data is provided. In the method, a conversion between a visual media file and a bitstream of visual media data is performed according to a format rule. For example, the bitstream may be a bitstream that is decoded/encoded in any of the decoding and/or encoding methods described herein. The format rule may specify one or more constraints of the bitstream and/or one or more processes to be performed by the decoder and/or encoder.

In an example, the bitstream carries coded information of a plurality of pictures. The format rule specifies that a current block in a current picture is coded using an inter prediction mode, prediction samples of the current block in the inter prediction mode are generated at least partially based on a reference block in a reference picture that is different from the current picture. The format rule also specifies that an intra prediction mode associated with the current block in the current picture is obtained, one or more transform kernels are determined based on the intra prediction mode associated with the current block, and the current block is reconstructed based on the one or more transform kernels.

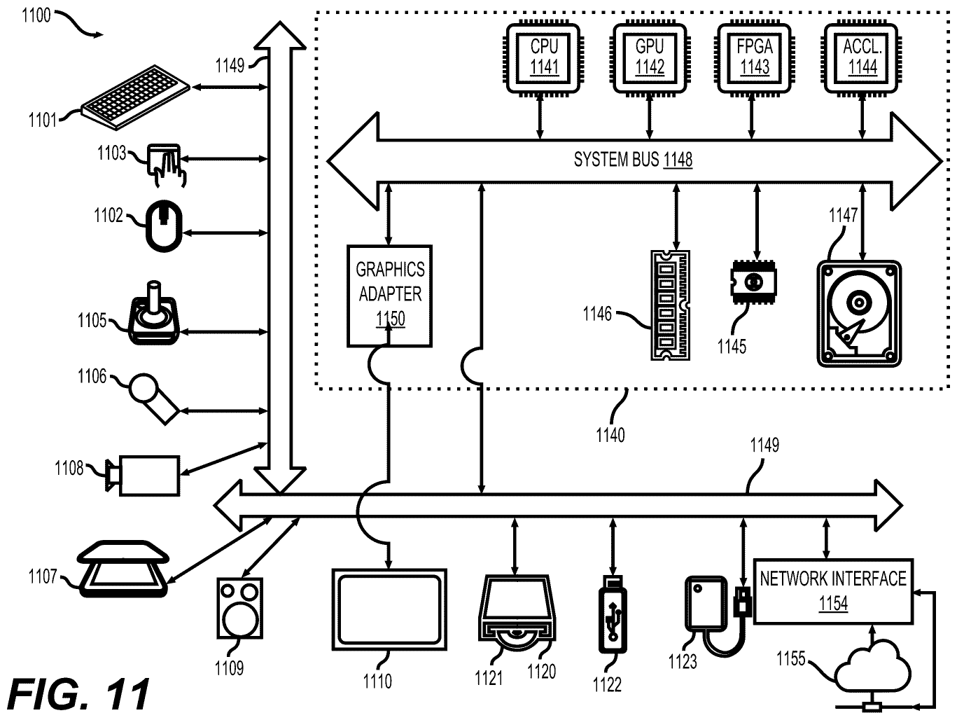

The techniques described above, can be implemented as computer software using computer-readable instructions and physically stored in one or more computer-readable media. For example, FIG. 11 shows a computer system (1100) suitable for implementing certain aspects of the disclosed subject matter.

The computer software can be coded using any suitable machine code or computer language, that may be subject to assembly, compilation, linking, or like mechanisms to create code comprising instructions that can be executed directly, or through interpretation, micro-code execution, and the like, by one or more computer central processing units (CPUs), Graphics Processing Units (GPUs), and the like.

The instructions can be executed on various types of computers or components thereof, including, for example, personal computers, tablet computers, servers, smartphones, gaming devices, internet of things devices, and the like.

The components shown in FIG. 11 for computer system (1100) are examples and are not intended to suggest any limitation as to the scope of use or functionality of the computer software implementing aspects of the present disclosure. Neither should the configuration of components be interpreted as having any dependency or requirement relating to any one or combination of components illustrated in the example aspect of computer system (1100).

Computer system (1100) may include certain human interface input devices. Such a human interface input device may be responsive to input by one or more human users through, for example, tactile input (such as: keystrokes, swipes, data glove movements), audio input (such as: voice, clapping), visual input (such as: gestures), olfactory input (not depicted). The human interface devices can also be used to capture certain media not necessarily directly related to conscious input by a human, such as audio (such as: speech, music, ambient sound), images (such as: scanned images, photographic images obtain from a still image camera), video (such as two-dimensional video, three-dimensional video including stereoscopic video).

Input human interface devices may include one or more of (only one of each depicted): keyboard (1101), mouse (1102), trackpad (1103), touch screen (1110), data-glove (not shown), joystick (1105), microphone (1106), scanner (1107), camera (1108).

Computer system (1100) may also include certain human interface output devices. Such human interface output devices may be stimulating the senses of one or more human users through, for example, tactile output, sound, light, and smell/taste. Such human interface output devices may include tactile output devices (for example tactile feedback by the touch-screen (1110), data-glove (not shown), or joystick (1105), but there can also be tactile feedback devices that do not serve as input devices), audio output devices (such as: speakers (1109), headphones (not depicted)), visual output devices (such as screens (1110) to include CRT screens, LCD screens, plasma screens, OLED screens, each with or without touch-screen input capability, each with or without tactile feedback capability-some of which may be capable to output two dimensional visual output or more than three dimensional output through means such as stereographic output; virtual-reality glasses (not depicted), holographic displays and smoke tanks (not depicted)), and printers (not depicted).

Computer system (1100) can also include human accessible storage devices and their associated media such as optical media including CD/DVD ROM/RW (1120) with CD/DVD or the like media (1121), thumb-drive (1122), removable hard drive or solid state drive (1123), legacy magnetic media such as tape and floppy disc (not depicted), specialized ROM/ASIC/PLD based devices such as security dongles (not depicted), and the like.

Those skilled in the art should also understand that term “computer readable media” as used in connection with the presently disclosed subject matter does not encompass transmission media, carrier waves, or other transitory signals.

Computer system (1100) can also include an interface (1154) to one or more communication networks (1155). Networks can for example be wireless, wireline, optical. Networks can further be local, wide-area, metropolitan, vehicular and industrial, real-time, delay-tolerant, and so on. Examples of networks include local area networks such as Ethernet, wireless LANs, cellular networks to include GSM, 3G, 4G, 5G, LTE and the like, TV wireline or wireless wide area digital networks to include cable TV, satellite TV, and terrestrial broadcast TV, vehicular and industrial to include CANBus, and so forth. Certain networks commonly require external network interface adapters that attached to certain general purpose data ports or peripheral buses (1149) (such as, for example USB ports of the computer system (1100)); others are commonly integrated into the core of the computer system (1100) by attachment to a system bus as described below (for example Ethernet interface into a PC computer system or cellular network interface into a smartphone computer system). Using any of these networks, computer system (1100) can communicate with other entities. Such communication can be uni-directional, receive only (for example, broadcast TV), uni-directional send-only (for example CANbus to certain CANbus devices), or bi-directional, for example to other computer systems using local or wide area digital networks. Certain protocols and protocol stacks can be used on each of those networks and network interfaces as described above.

Aforementioned human interface devices, human-accessible storage devices, and network interfaces can be attached to a core (1140) of the computer system (1100).

The core (1140) can include one or more Central Processing Units (CPU) (1141), Graphics Processing Units (GPU) (1142), specialized programmable processing units in the form of Field Programmable Gate Areas (FPGA) (1143), hardware accelerators for certain tasks (1144), graphics adapters (1150), and so forth. These devices, along with Read-only memory (ROM) (1145), Random-access memory (1146), internal mass storage such as internal non-user accessible hard drives, SSDs, and the like (1147), may be connected through a system bus (1148). In some computer systems, the system bus (1148) can be accessible in the form of one or more physical plugs to enable extensions by additional CPUs, GPU, and the like. The peripheral devices can be attached either directly to the core's system bus (1148), or through a peripheral bus (1149). In an example, the screen (1110) can be connected to the graphics adapter (1150). Architectures for a peripheral bus include PCI, USB, and the like.

CPUs (1141), GPUs (1142), FPGAs (1143), and accelerators (1144) can execute certain instructions that, in combination, can make up the aforementioned computer code. That computer code can be stored in ROM (1145) or RAM (1146). Transitional data can also be stored in RAM (1146), whereas permanent data can be stored for example, in the internal mass storage (1147). Fast storage and retrieve to any of the memory devices can be enabled through the use of cache memory, that can be closely associated with one or more CPU (1141), GPU (1142), mass storage (1147), ROM (1145), RAM (1146), and the like.

The computer readable media can have computer code thereon for performing various computer-implemented operations. The media and computer code can be those specially designed and constructed for the purposes of the present disclosure, or they can be of the kind well known and available to those having skill in the computer software arts.

As an example and not by way of limitation, the computer system having architecture (1100), and specifically the core (1140) can provide functionality as a result of processor(s) (including CPUs, GPUs, FPGA, accelerators, and the like) executing software embodied in one or more tangible, computer-readable media. Such computer-readable media can be media associated with user-accessible mass storage as introduced above, as well as certain storage of the core (1140) that are of non-transitory nature, such as core-internal mass storage (1147) or ROM (1145). The software implementing various aspects of the present disclosure can be stored in such devices and executed by core (1140). A computer-readable medium can include one or more memory devices or chips, according to particular needs. The software can cause the core (1140) and specifically the processors therein (including CPU, GPU, FPGA, and the like) to execute particular processes or particular parts of particular processes described herein, including defining data structures stored in RAM (1146) and modifying such data structures according to the processes defined by the software. In addition or as an alternative, the computer system can provide functionality as a result of logic hardwired or otherwise embodied in a circuit (for example: accelerator (1144)), which can operate in place of or together with software to execute particular processes or particular parts of particular processes described herein. Reference to software can encompass logic, and vice versa, where appropriate. Reference to a computer-readable media can encompass a circuit (such as an integrated circuit (IC)) storing software for execution, a circuit embodying logic for execution, or both, where appropriate. The present disclosure encompasses any suitable combination of hardware and software.

The use of “at least one of” or “one of” in the disclosure is intended to include any one or a combination of the recited elements. For example, references to at least one of A, B, or C; at least one of A, B, and C; at least one of A, B, and/or C; and at least one of A to C are intended to include only A, only B, only C or any combination thereof. References to one of A or B and one of A and B are intended to include A or B or (A and B). The use of “one of” does not preclude any combination of the recited elements when applicable, such as when the elements are not mutually exclusive.

While this disclosure has described several examples of aspects, there are alterations, permutations, and various substitute equivalents, which fall within the scope of the disclosure. It will thus be appreciated that those skilled in the art will be able to devise numerous systems and methods which, although not explicitly shown or described herein, embody the principles of the disclosure and are thus within the spirit and scope thereof.

The above disclosure also encompasses the features noted below. The features may be combined in various manners and are not limited to the combinations noted below.
(1). A method of video decoding, including: receiving a coded video bitstream including coded information of a plurality of pictures; determining, based on the coded information, that a current block in a current picture is coded using an inter prediction mode, prediction samples of the current block in the inter prediction mode being generated at least partially based on a reference block in a reference picture that is different from the current picture; obtaining an intra prediction mode associated with the current block in the current picture; determining one or more transform kernels based on the intra prediction mode associated with the current block; and reconstructing the current block based on the one or more transform kernels.
(2). The method of feature (1), in which the reconstructing includes: decoding transform coefficients of the current block from the coded information; applying one or more inverse transforms on the transform coefficients based on the one or more transform kernels to calculate residual values for samples in the current block; and reconstructing the samples of the current block based on the residual values and a prediction of the current block, the prediction of the current block being at least partially based on the reference block in the reference picture.
(3). The method of any of features (1) to (2), in which the current block is coded in at least one of a combined inter and intra prediction (CIIP) mode and a geometric partition mode (GPM). When the current block is coded in a combined inter and intra prediction (CIIP) mode, the CIIP mode includes the intra prediction mode for generating an intra prediction part of the prediction samples. When the current block is coded in a geometric partition mode (GPM), a partition of the current block is coded in the intra prediction mode.
(4). The method of any of features (1) to (3), in which the determining the one or more transform kernels includes: determining the one or more transform kernels according to a predefined mapping table that maps the intra prediction mode to the one or more transform kernels.
(5). The method of any of features (1) to (4), in which the obtaining the intra prediction mode includes at least one of: obtaining the intra prediction mode that is a predefined intra prediction mode; obtaining the intra prediction mode based on a signal in the coded video bitstream that indicates the intra prediction mode; and/or obtaining the intra prediction mode according to a decoder-side derived intra prediction mode.
(6). The method of any of features (1) to (5), in which the obtaining the intra prediction mode includes: calculating template cost values respectively for a plurality of candidate intra prediction modes; and determining, from the plurality of candidate intra prediction modes, the intra prediction mode with a least template cost value.
(7). The method of any of features (1) to (6), in which the obtaining the intra prediction mode includes: calculating template cost values respectively for a plurality of candidate intra prediction modes; forming a list including two or more candidate intra prediction modes of the plurality of candidate intra prediction modes according to the template cost values, the two or more candidate intra prediction modes being ordered in the list according to the template cost values; and selecting the intra prediction mode from the list.
(8). The method of any of features (1) to (7), in which the selecting includes: decoding a syntax from the coded video bitstream, the syntax indicating an index in the list; and selecting the intra prediction mode from the list according to the syntax.
(9). The method of any of features (1) to (8), in which the selecting includes: calculating second cost values respectively for the two or more candidate intra prediction modes in the list; and selecting the intra prediction mode from the list based on the second cost values.
(10). The method of any of features (1) to (9), in which the obtaining the intra prediction mode includes: ordering a first candidate intra prediction mode and a second candidate intra prediction mode in a list; decoding a flag from the coded video bitstream; and selecting one of the first candidate intra prediction mode and the second candidate intra prediction mode as the intra prediction mode based on the flag.
(11). The method of any of features (1) to (10), in which the one or more transform kernels include at least one of: a primary transform kernel; a secondary transform kernel; a low-frequency non-separable transform (LFNST) kernel; and/or a non-separable primary transform kernel.
(12). The method of any of features (1) to (11), in which the obtaining the intra prediction mode includes: counting occurrence numbers of used intra prediction modes by neighboring blocks in a predefined area of the current block; and determining, from the used intra prediction modes, the intra prediction mode of a most frequency occurrence number.
(13). The method of any of features (1) to (12), in which the obtaining the intra prediction mode includes: counting occurrence numbers of used intra prediction modes by neighboring blocks in a predefined area of the current block; forming a list including two or more used intra prediction modes of the used intra prediction modes according to the occurrence numbers, the two or more used intra prediction modes being ordered in the list according to the occurrence numbers; and selecting the intra prediction mode from the list.
(14). The method of any of features (1) to (13), in which the selecting includes: decoding a syntax from the coded video bitstream, the syntax indicating an index in the list; and selecting the intra prediction mode from the list according to the syntax.
(15). The method of any of features (1) to (14), in which the selecting includes: calculating cost values respectively for the two or more used intra prediction modes in the list; and selecting the intra prediction mode from the list based on the cost values.
(16). The method of any of features (1) to (15), in which the obtaining the intra prediction mode includes: deriving the intra prediction mode according to a decoder side intra prediction mode derivation when the current block is coded using at least one of a planar mode, a planar horizontal mode, a planar vertical mode, a DC mode and/or a pre-defined intra mode.
(17). The method of any of features (1) to (16), in which the current block is coded in a geometric partition mode (GPM), and the obtaining the intra prediction mode includes: determining the intra prediction mode with an angle that is parallel or perpendicular to a partition boundary of the current block.
(18). A method of video encoding, including: determining to code a current block in a current picture using an inter prediction mode; generating prediction samples for samples of the current block at least partially based on a reference block in a reference picture that is different from the current picture; obtaining an intra prediction mode associated with the current block in the current picture; determining one or more transform kernels based on the intra prediction mode associated with the current block; and encoding the current block as bits in a bitstream based on the one or more transform kernels.
(19). The method of feature (18), in which the encoding includes: applying one or more transforms on residual values of the samples in the current block according to the one or more transform kernels to calculate transform coefficients, the residual values being calculated based on prediction samples and original values of the samples in the current block; and encoding the transform coefficients as bits in the bitstream.
(20). The method of any of features (18) to (19), in which the inter prediction mode is at least one of a combined inter and intra prediction (CIIP) mode and a geometric partition mode (GPM). When the current block is coded in a combined inter and intra prediction (CIIP) mode, the CIIP mode includes the intra prediction mode for generating an intra prediction part of the prediction samples. When the current block is coded in a geometric partition mode (GPM), a partition of the current block is coded in the intra prediction mode.
(21). The method of any of features (18) to (20), in which the determining the one or more transform kernels includes: determining the one or more transform kernels according to a predefined mapping table that maps the intra prediction mode to the one or more transform kernels.
(22). The method of any of features (18) to (21), in which the obtaining the intra prediction mode includes at least one of: obtaining the intra prediction mode that is a predefined intra prediction mode; and/or obtaining the intra prediction mode according to a decoder-side derived intra prediction mode.
(23). The method of any of features (18) to (22), further including: encoding a syntax indicating of the intra prediction mode as one or more bits in the bitstream.
(24). The method of any of features (18) to (23), in which the obtaining the intra prediction mode includes: calculating template cost values respectively for a plurality of candidate intra prediction modes; and determining, from the plurality of candidate intra prediction modes, the intra prediction mode with a least template cost value.
(25). The method of any of features (18) to (24), in which the obtaining the intra prediction mode includes: calculating template cost values respectively for a plurality of candidate intra prediction modes; forming a list including two or more candidate intra prediction modes of the plurality of candidate intra prediction modes according to the template cost values, the two or more candidate intra prediction modes being ordered in the list according to the template cost values; and selecting the intra prediction mode from the list.
(26). The method of any of features (18) to (25), further including: encoding a syntax as one or more bits in the bitstream, the syntax indicating an index of the intra prediction mode in the list.
(27). The method of any of features (18) to (26), in which the selecting includes: calculating second cost values respectively for the two or more candidate intra prediction modes in the list; and selecting the intra prediction mode from the list based on the second cost values.
(28). The method of any of features (18) to (27), in which the obtaining the intra prediction mode includes: selecting one of a first candidate intra prediction mode and a second candidate intra prediction mode as the intra prediction mode; and encoding a flag in the bitstream, the flag indicating the one of the first candidate intra prediction mode and the second candidate intra prediction mode.
(29). The method of any of features (18) to (28), in which the one or more transform kernels include at least one of: a primary transform kernel; a secondary transform kernel; a low-frequency non-separable transform (LFNST) kernel; and/or a non-separable primary transform kernel.
(30). The method of any of features (18) to (29), in which the obtaining the intra prediction mode includes: counting occurrence numbers of used intra prediction modes by neighboring blocks in a predefined area of the current block; and determining, from the used intra prediction modes, the intra prediction mode of a most frequency occurrence number.
(31). The method of any of features (18) to (30), in which the obtaining the intra prediction mode includes: counting occurrence numbers of used intra prediction modes by neighboring blocks in a predefined area of the current block; forming a list including two or more used intra prediction modes of the used intra prediction modes according to the occurrence numbers, the two or more used intra prediction modes being ordered in the list according to the occurrence numbers; and selecting the intra prediction mode from the list.
(32). The method of any of features (18) to (31), further including: encoding a syntax as one or more bits om bitstream, the syntax indicating an index of the intra prediction mode in the list.
(33). The method of any of features (18) to (32), in which the selecting includes: calculating cost values respectively for the two or more used intra prediction modes in the list; and selecting the intra prediction mode from the list based on the cost values.
(34). The method of any of features (18) to (33), in which the obtaining the intra prediction mode includes: deriving the intra prediction mode according to a decoder side intra prediction mode derivation when the current block is coded using at least one of a planar mode, a planar horizontal mode, a planar vertical mode, a DC mode, and/or a pre-defined intra mode.
(35). The method of any of features (18) to (34), in which the current block is coded in a geometric partition mode (GPM), and the obtaining the intra prediction mode includes: determining the intra prediction mode with an angle that is parallel or perpendicular to a partition boundary of the current block.
(36). A method of processing visual media data, the method including: processing a bitstream that includes the visual media data according to a format rule, in which: the bitstream carries a plurality of pictures; and the format rule specifies that: a current block in a current picture is coded using an inter prediction mode, prediction samples of the current block in the inter prediction mode being generated at least partially based on a reference block in a reference picture that is different from the current picture; an intra prediction mode associated with the current block in the current picture is obtained; one or more transform kernels are determined based on the intra prediction mode associated with the current block; and the current block is reconstructed based on the one or more transform kernels.
(37). An apparatus for video decoding, including processing circuitry that is configured to perform the method of any of features (1) to (17).
(38). An apparatus for video encoding, including processing circuitry that is configured to perform the method of any of features (18) to (35).
(39). A non-transitory computer-readable storage medium storing instructions which when executed by at least one processor cause the at least one processor to perform the method of any of features (1) to (36).

What is claimed is:

1. A method of video decoding, comprising:
receiving a coded video bitstream comprising coded information of a plurality of pictures;
determining, based on the coded information, that a current block in a current picture is coded using an inter prediction mode, prediction samples of the current block in the inter prediction mode being generated at least partially based on a reference block in a reference picture that is different from the current picture;
obtaining an intra prediction mode associated with the current block in the current picture;
determining one or more transform kernels based on the intra prediction mode associated with the current block; and
reconstructing the current block based on the one or more transform kernels.

2. The method of claim 1, wherein the reconstructing comprises:
decoding transform coefficients of the current block from the coded information;
applying one or more inverse transforms on the transform coefficients based on the one or more transform kernels to calculate residual values for samples in the current block; and
reconstructing the samples of the current block based on the residual values and a prediction of the current block, the prediction of the current block being at least partially based on the reference block in the reference picture.

3. The method of claim 1, wherein:
when the current block is coded in a combined inter and intra prediction (CIIP) mode, the CIIP mode includes the intra prediction mode for generating an intra prediction part of the prediction samples; and
when the current block is coded in a geometric partition mode (GPM), a partition of the current block is coded in the intra prediction mode.

4. The method of claim 1, wherein the determining the one or more transform kernels comprises:
determining the one or more transform kernels according to a predefined mapping table that maps the intra prediction mode to the one or more transform kernels.

5. The method of claim 1, wherein the obtaining the intra prediction mode comprises at least one of:
obtaining the intra prediction mode that is a predefined intra prediction mode;
obtaining the intra prediction mode based on a signal in the coded video bitstream that indicates the intra prediction mode; and/or
obtaining the intra prediction mode according to a decoder-side derived intra prediction mode.

6. The method of claim 1, wherein the obtaining the intra prediction mode comprises:
calculating template cost values respectively for a plurality of candidate intra prediction modes; and
determining, from the plurality of candidate intra prediction modes, the intra prediction mode with a least template cost value.

7. The method of claim 1, wherein the obtaining the intra prediction mode comprises:
calculating template cost values respectively for a plurality of candidate intra prediction modes;
forming a list including two or more candidate intra prediction modes of the plurality of candidate intra prediction modes according to the template cost values, the two or more candidate intra prediction modes being ordered in the list according to the template cost values; and
selecting the intra prediction mode from the list.

8. The method of claim 7, wherein the selecting comprises:
decoding a syntax from the coded video bitstream, the syntax indicating an index in the list; and
selecting the intra prediction mode from the list according to the syntax.

9. The method of claim 7, wherein the selecting comprises:
calculating second cost values respectively for the two or more candidate intra prediction modes in the list; and
selecting the intra prediction mode from the list based on the second cost values.

10. The method of claim 1, wherein the obtaining the intra prediction mode comprises:
ordering a first candidate intra prediction mode and a second candidate intra prediction mode in a list;
decoding a flag from the coded video bitstream; and
selecting one of the first candidate intra prediction mode and the second candidate intra prediction mode as the intra prediction mode based on the flag.

11. The method of claim 1, wherein the one or more transform kernels comprise at least one of:
a primary transform kernel;
a secondary transform kernel;
a low-frequency non-separable transform (LFNST) kernel; and/or
a non-separable primary transform kernel.

12. The method of claim 1, wherein the obtaining the intra prediction mode comprises:
counting occurrence numbers of used intra prediction modes by neighboring blocks in a predefined area of the current block; and
determining, from the used intra prediction modes, the intra prediction mode of a most frequency occurrence number.

13. The method of claim 1, wherein the obtaining the intra prediction mode comprises:
counting occurrence numbers of used intra prediction modes by neighboring blocks in a predefined area of the current block;
forming a list including two or more used intra prediction modes of the used intra prediction modes according to the occurrence numbers, the two or more used intra prediction modes being ordered in the list according to the occurrence numbers; and
selecting the intra prediction mode from the list.

14. The method of claim 13, wherein the selecting comprises:
decoding a syntax from the coded video bitstream, the syntax indicating an index in the list; and
selecting the intra prediction mode from the list according to the syntax.

15. The method of claim 13, wherein the selecting comprises:
calculating cost values respectively for the two or more used intra prediction modes in the list; and
selecting the intra prediction mode from the list based on the cost values.

16. The method of claim 1, wherein the obtaining the intra prediction mode comprises:
deriving the intra prediction mode according to a decoder side intra prediction mode derivation when the current block is coded using at least one of a planar mode, a planar horizontal mode, a planar vertical mode, a DC mode, and/or a pre-defined intra mode.

17. The method of claim 1, wherein the current block is coded in a geometric partition mode (GPM), and the obtaining the intra prediction mode comprises:
determining the intra prediction mode with an angle that is parallel or perpendicular to a partition boundary of the current block.

18. A method of video encoding, comprising:
determining to code a current block in a current picture using an inter prediction mode;
generating prediction samples for samples of the current block at least partially based on a reference block in a reference picture that is different from the current picture;
obtaining an intra prediction mode associated with the current block in the current picture;
determining one or more transform kernels based on the intra prediction mode associated with the current block; and
encoding the current block as bits in a bitstream based on the one or more transform kernels.

19. The method of claim 18, wherein the encoding comprises:
applying one or more transforms on residual values of the samples in the current block according to the one or more transform kernels to calculate transform coefficients, the residual values being calculated based on prediction samples and original values of the samples in the current block; and
encoding the transform coefficients as bits in the bitstream.

20. A method of processing visual media data, the method comprising:
processing a bitstream that includes the visual media data according to a format rule, wherein:
the bitstream carries a plurality of pictures; and
the format rule specifies that:
a current block in a current picture is coded using an inter prediction mode, prediction samples of the current block in the inter prediction mode being generated at least partially based on a reference block in a reference picture that is different from the current picture;
an intra prediction mode associated with the current block in the current picture is obtained;
one or more transform kernels are determined based on the intra prediction mode associated with the current block; and
the current block is reconstructed based on the one or more transform kernels.
